(19) United States
(12) Patent Application Publication
(10) Pub. No.: US 2007/0144555 A1
(43) Pub. Date: Jun. 28, 2007

(54) Supercritical CO2 cleaning system and method

(75) Inventors: Cheng-Chun Chen, Tainan County (TW); Shing Chen, Hsinchu County (TW); Chuan-Hui Liu, Hsinchu County (TW); Jia-Ming Huang, Hsinchu City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, HsinChu (TW)

(21) Appl. No.: 11/519,899

(22) Filed: Sep. 13, 2006

(30) Foreign Application Priority Data
Dec. 27, 2005 (TW) 94146613

(51) Int. Cl. B08B 3/12; B08B 3/00; B08B 6/00

(52) U.S. Cl. 134/1; 134/172; 134/184; 134/198; 134/34

(57) ABSTRACT

A supercritical CO₂ cleaning system is provided, comprising: a closed high-pressure cleaning trough, which is a funnel-shaped vessel tapered from top to bottom; a bearer platform, located within the closed high-pressure cleaning trough and rotated with respect to an object to be cleaned and used for bearing the object to be cleaned; and a movable nozzle set, disposed within the closed high-pressure cleaning trough and above the bearer platform, wherein the object to be cleaned can be cleaned via the movable nozzle set and impurity pollutants will be easily deposited at the bottom of the closed high-pressure cleaning trough after cleaning. A supercritical CO₂ cleaning method is also provided, comprising: providing a wafer or an object to be cleaned within a closed high-pressure cleaning trough; introducing liquid CO₂ into the closed high-pressure cleaning trough; adding co-solvents and surfactants into the cleaning trough; activating a movable nozzle set in order to increase the cleaning performance; rotating the wafer or the object to be cleaned to remove the impurity pollutants; and lowering the pressure to discharge the CO₂ and the impurity pollutants in order to clean the wafer or the object to be cleaned.

### BACKGROUND OF THE INVENTION

1. Field of the Invention

The present invention relates to a supercritical CO₂ cleaning system and method, and more particularly to a supercritical CO₂ cleaning system and method for cleaning an object to be cleaned located on a bearer platform in a closed high-pressure cleaning trough.

2. Description of the Related Art

In traditional cleaning processes for wafers or elements, a lot of super pure water and chemical solvents are needed to remove nanopollutants on the surface of a wafer or element. At the same time, a lot of waste solvents will be treated. In a nanoprocess (65 nm) or a more complex process, the pollutants in nanoholes in the trenches and the high aspect ration structures of a wafer or element can not be efficiently cleaned due to the limit of the liquid surface boundary layer.

In past technologies, wafers or elements can be cleaned by ozone water, however, these wafers or elements are stationary and unable to be rotated. Furthermore, these wafers or elements have to be cleaned in conjunction with a MHz class ultrasonic wave and dried by high-pressure CO₂. In another technology, wafers or elements can be cleaned by water in conjunction with an ultrasonic wave having a frequency of 900˜1,100 KHz. It is noted that, the ultrasonic wave apparatus is provided outside the cleaning trough, but the cleaning time and efficiency still needed to be improved.

The above methods for cleaning elements such as wafers by ozone water or water are gradually replaced by new technologies, for example supercritical fluid matters. A supercritical fluid matter has physical properties between those of a gaseous matter and a liquid matter. The viscosity of a supercritical fluid matter is close to that of a gaseous matter, and the density of a supercritical fluid matter is close to that of a liquid matter. For its higher density, more supercritical fluid matters can be transported than gaseous matters. For its lower viscosity, the power needed for transporting a supercritical fluid matter is lower than that of a liquid matter, that is, the mass transport resistance of a supercritical fluid matter is much lower than that of a liquid matter such that the mass transport of a supercritical fluid matter is faster than that of a liquid matter. Additionally, similar to a gaseous matter, a supercritical fluid matter has nearly no surface tension, such that it can easily permeate into a porous texture.

In addition these physical properties, a supercritical fluid matter also has different chemical properties from a gaseous matter and a liquid matter. For example, CO₂ does not have any extraction capability in gaseous state, however, after entering the supercritical state, it will become organophilic and therefore capable of dissolving organic matters. The dissolving capability will vary with the temperature and the pressure. A supercritical CO₂ has the properties of low surface tension, low viscosity, and high diffusibility, such that it can easily diffuse into nanoholes, thereby it can be used for a dry cleaning process and reduce the waste of water resource. Accordingly, it is a potential ┌Green Cleaning and Producing Technology┘.

However, as to the current supercritical CO₂ cleaning system and method, a simple, convenient, and efficient supercritical CO₂ cleaning system is still needed such that the cleaning time can be reduced.

### SUMMARY OF THE INVENTION

It is one object of the present invention to provide a supercritical CO₂ cleaning system and method for increasing the cleaning efficiency and shortening the cleaning time.

To achieve the above purposes, a supercritical CO₂ cleaning system of the present invention comprises: a closed high-pressure cleaning trough, which is a funnel-shaped vessel tapered from top to bottom; a bearer platform, located within the closed high-pressure cleaning trough and rotated with respect to an object to be cleaned and used for bearing the object to be cleaned; and a movable nozzle set, disposed within the closed high-pressure cleaning trough and above the bearer platform, wherein the object to be cleaned can be cleaned via the movable nozzle set and impurity pollutants will be easily deposited at the bottom of the closed high-pressure cleaning trough after cleaning, furthermore the cleaning performance is increased in conjunction with co-solvents, surfactants, and chelating agents and the cleaning time is shortened in conjunction with micro-emulsification technology.

Additionally, to achieve the above purposes, a supercritical CO₂ cleaning method of the present invention comprises the following steps: providing a wafer or an object to be cleaned within a closed high-pressure cleaning trough; introducing liquid CO₂ into the closed high-pressure cleaning trough; adding co-solvents and surfactants into the cleaning trough; activating a movable nozzle set in order to increase the cleaning performance; rotating the object to be cleaned to remove the impurity pollutants; and lowering the pressure to discharge the CO₂ and the impurity pollutants. Additionally, suitable co-solvents, surfactants, and chelating agents can also be used to push the supercritical CO₂ into a steady and homogenous state and increase the polarities of the CO₂ in order to bring its cleaning performance into full play, the suitable combination can be made in accordance with the object to be cleaned. Wherein after the CO₂ and the impurity pollutants are discharged, another cleaning can be performed on the object to be cleaned by fresh CO₂, and the object to be cleaned can be taken out after this another cleaning.

The above supercritical CO₂ cleaning system and method has the advantages of increasing the cleaning efficiency and shortening the cleaning time.

### BRIEF DESCRIPTION OF THE DRAWINGS

FIG. 1 is a cross-sectional view of a supercritical CO₂ cleaning system according to the present invention.

FIG. 2 is a flow chart of a supercritical CO₂ cleaning method according to the present invention.

FIG. 3A to 3D are cross-sectional views of a ultrasonic convergent nozzle of the supercritical CO₂ cleaning system according to the present invention.

FIG. 4A to 4D are top views of a movable nozzle set of the supercritical CO₂ cleaning system according to the present invention. FIG. 5 illustrates a diagram for the cleaning principle of a supercritical CO₂ according to the present invention.

### DETAILED DESCRIPTION OF THE PREFERRED EMBODIMENTS

The inventive supercritical CO₂ cleaning system and method will be illustrated by detailed description of the embodiment with reference to accompanying drawings.

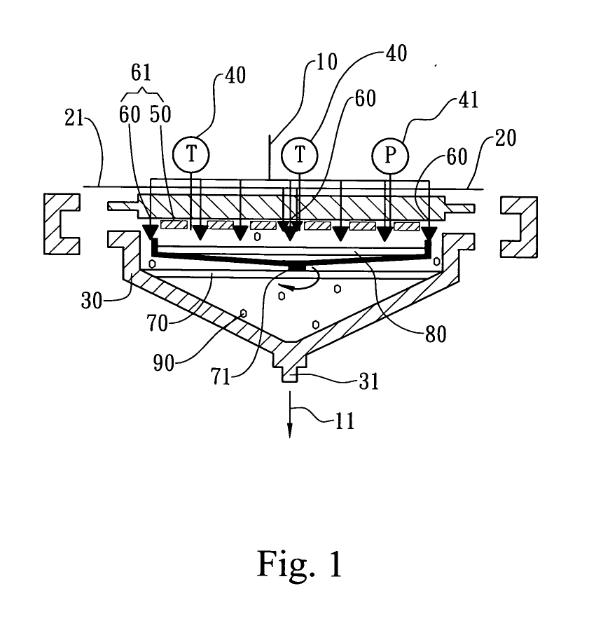

Referring to FIG. 1, a preferred embodiment of the supercritical CO₂ cleaning system is shown, comprising a closed high-pressure cleaning trough 30, a bearer platform 70, and a movable nozzle set 61. The closed high-pressure cleaning trough 30 is a funnel-shaped vessel tapered from top to bottom, such that a space for the bearer platform 70 which can bear an object to be cleaned 80 and for the movable nozzle set 61 is provided, in order to be cleaned by the supercritical CO₂ and facilitate the deposition of impurity pollutants 90. The bearer platform 70 is located within the closed high-pressure cleaning trough 30 and rotated with respect to the object to be cleaned and used for bearing the object to be cleaned 80. And the movable nozzle set 61 is disposed within the closed high-pressure cleaning trough 30 and above the bearer platform 70, such that the supercritical CO₂ can clean the object to be cleaned 80 via the movable nozzle set 61.

At first, an object to be cleaned 80 is put on the bearer platform 70 within the closed cleaning trough 30. The object to be cleaned 80, for example, may be a wafer, low-k material, or MEMS etc. A surface treatment can be performed on the surface at which the object to be cleaned 80 will solidly contact the bearer platform 70 in order to increase the contact friction, such that the object to be cleaned or the wafer 80 can closely contact the bearer platform 70. Then, fresh CO₂ 10 can be introduce into the closed cleaning trough 30, because a high temperature and high pressure process has been performed such that the CO₂ 10 will automatically inject into the cleaning trough 30 via the movable nozzle set 61. At the time for cleaning, a suitable combination of a co-solvent 20 and a surfactant 21 can also be put into the cleaning trough 30 to achieve the purpose of shortening the cleaning time. Furthermore, auxiliary ultrasonic oscillators 50 can be activated in order to achieve the purposes of shortening the cleaning time and increasing the cleaning performance.

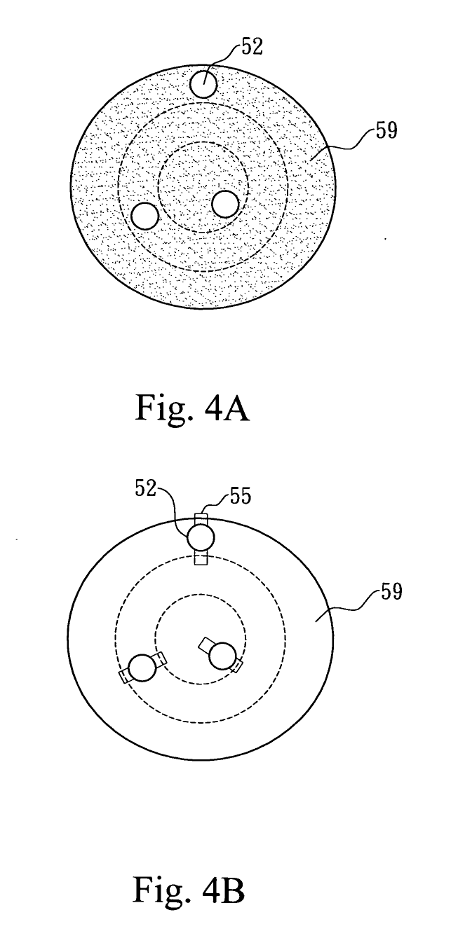

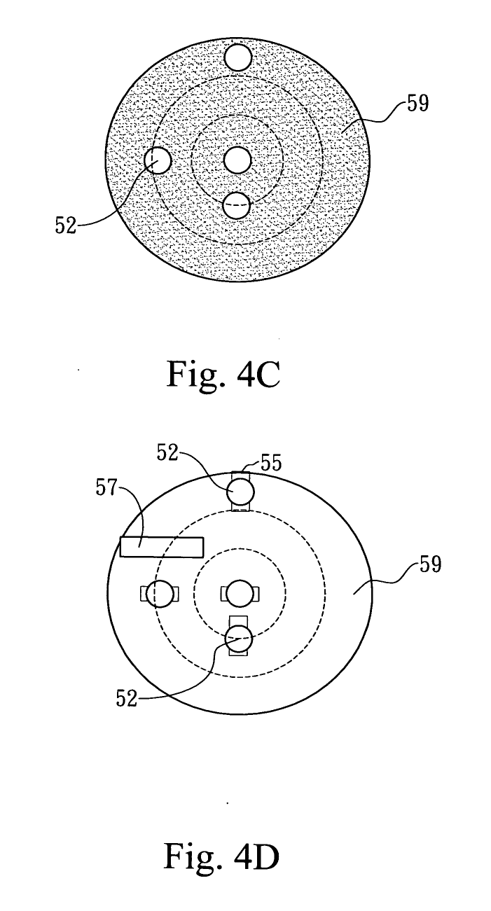

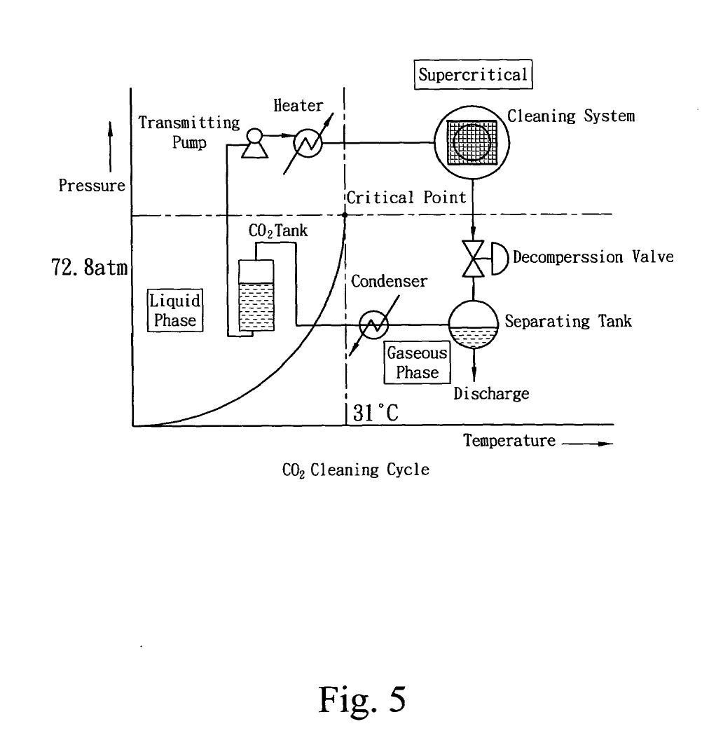

The position at which the movable nozzle set 61 is disposed is determined in accordance with the position of the object to be cleaned 80. An auxiliary ultrasonic oscillator 50 can be combined with a movable nozzle 60 as a module and the module formed of an auxiliary ultrasonic oscillator 50 combined with a movable nozzle 60 can be furthermore combined with the bearer platform 70 by mounting the module above or beneath the bearer platform 70. When the object to be cleaned 80 is put on the bearer platform 70 within the cleaning trough 30, the object to be cleaned 80 will be rotated with respect to the rotation axis 71 in the cleaning system, in order to remove the impurity pollutants 90. Moreover, the number of the nozzles in the movable nozzle set 61 and their respective positions are configured such that the respective working ranges of these nozzles will overlap with one another, thereby the whole cleaning area of the object to be cleaned 80 can be covered. The movable nozzle set 61 can operate with the ultrasonic oscillators 50 in order to increase the cleaning performance. Similarly, the number of the ultrasonic oscillators 50 and their respective positions are configured such that the respective working ranges of these ultrasonic oscillators 50 will overlap with one another, thereby the whole cleaning area of the object to be cleaned 80 can be covered. Referring to FIG. 4A to 4D, the movable nozzle set 61, even along with the ultrasonic oscillators 50, may have different arrangements for the same working range, such that the respective working ranges will overlap with one another, thereby the whole cleaning area of the object to be cleaned 80 can be covered. The differences among FIG. 4B and FIG. 4D and FIG. 4A and FIG. 4C are in that with or without the ultrasonic oscillators 50.

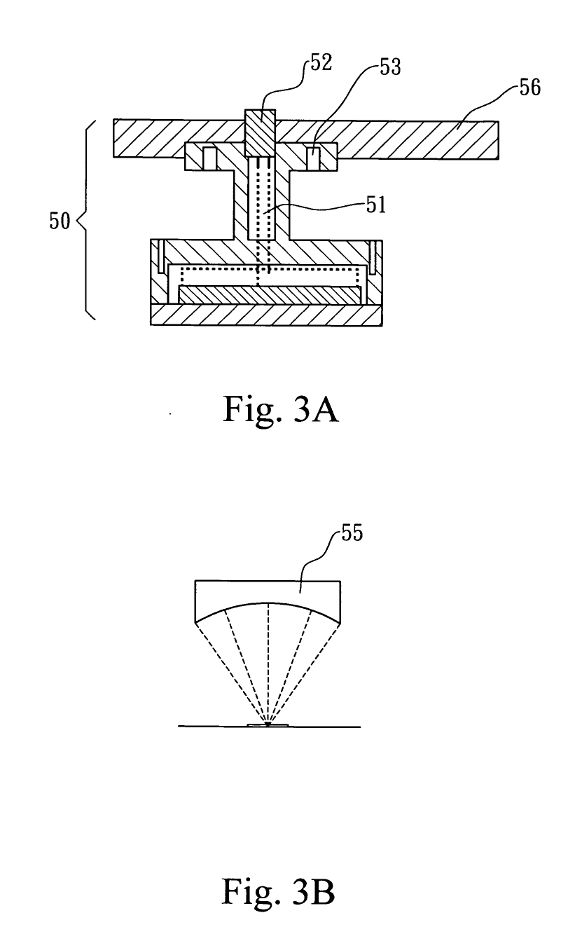

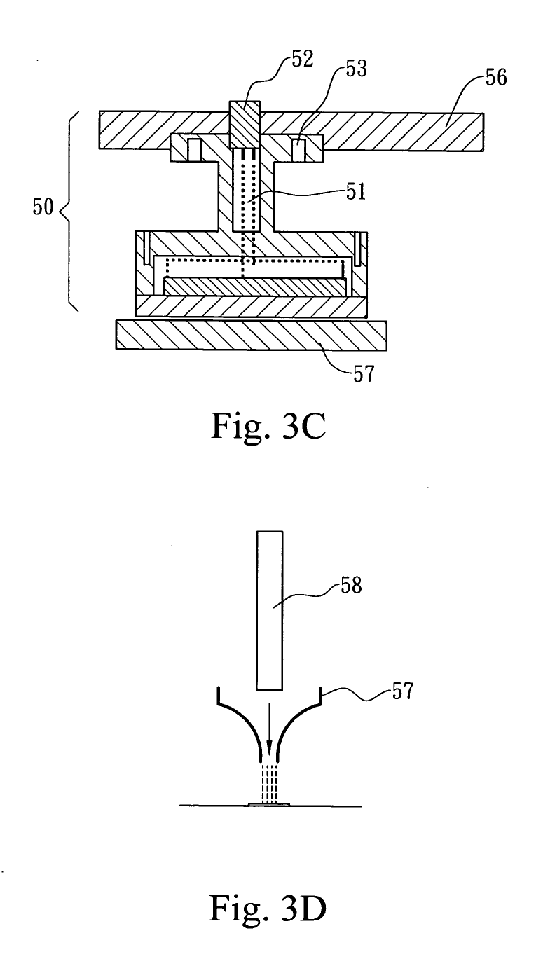

It is noted that, an ultrasonic oscillator 50 can be combined with a movable nozzle 60 to form a movable nozzle set 61 in which a connector 52 is disposed on a fixed base 56 and the oscillator is fixed to the base 56 via a bolt 53, and the connector 52 will connect the oscillator along a high-pressure resisting tube 51. The wires will be embedded within the high-pressure resisting tube 51 in order to avoid polluting the cleaning process. The surface of the oscillator is a concave 55, such that when the movable nozzle set 61 is used for cleaning, referring to FIG. 3A and FIG. 3B, CO₂ will inject out via the ultrasonic oscillator 50 and will converge on the area to be cleaned 59. Alternatively, a convergent amplifier 57 tapered from one end to the other end having a structure like a horn can be used, referring to FIG. 3C and FIG. 3D. Similarly, CO₂ will inject out via the ultrasonic oscillator 50 and will converge on the area to be cleaned 59. The ultrasonic oscillator 50 here can be regarded as an ultrasonic probe 58 underneath which the convergent amplifier 57 is disposed. When CO₂ injects out, it will be driven into the convergent amplifier 57 by the ultrasonic probe 58, such that further convergence is achieved. As shown in FIG. 4B and FIG. 4D, the convergent amplifier 57 can have any arrangement, as long as the desired cleaning area 59 can be covered.

Referring to FIG. 1 again, during the cleaning process, the impurity pollutants 90 will be extracted out by CO₂ and leave the object to be cleaned 80. And then the impurity pollutants 90 will converge on the bottom 31 of the cleaning trough 30 along the cleaning trough 30. Because the cleaning trough 30 is a funnel-shaped vessel tapered from top to bottom, such that the impurity pollutants 90 can easily converge on the bottom 31 of the cleaning trough. Dirty CO₂ 11 and the impurity pollutants 90 can leave the cleaning trough 30 by reducing the pressure, and then another cleaning can be performed on the object to be cleaned 80 by fresh CO₂ 10, and finally the cleaning operation is completed. Wherein, dirty CO₂ 11 can be recycled by a condenser or after being condensed into a liquid matter.

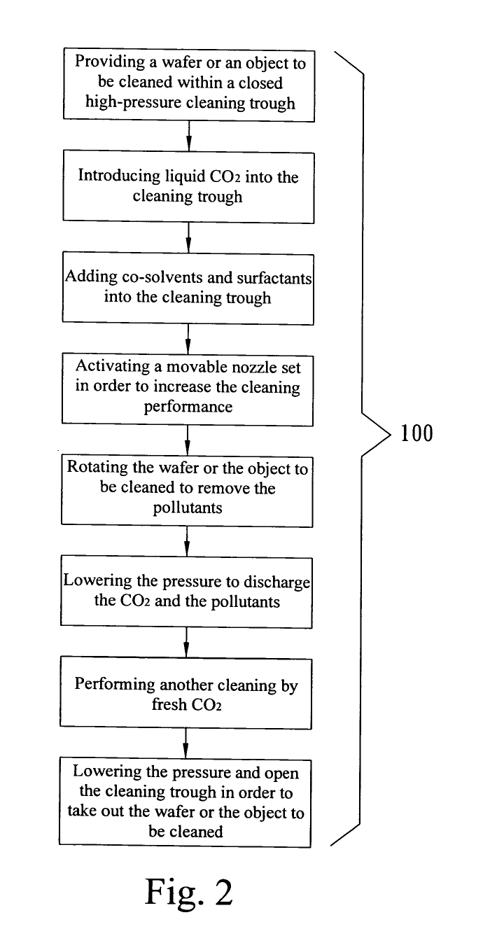

During the operation, the bearer platform 70 may be titled with respect to the horizontal plane with a suitable angle formed therebetween, such that the rotation axis 71 can easily rotate and the impurity pollutants 90 can therefore be easily taken away form the object to be cleaned 80 and the cleaning time can be shortened. The ultrasonic oscillators 50 can be disposed above or underneath the object to be cleaned 80 in order to increase the cleaning performance. Further, a suitable angle can also be formed between the movable nozzle set 61 and the object to be cleaned 80 in order to facilitate the cleaning operation and increase the cleaning performance. In summary, the operation conditions for CO₂ cleaning of the present invention are as follows: the temperature is defined between 15° C.˜150° C. and the pressure is defined between 50˜250 atm. In order to increase the cleaning performance, the additional ultrasonic set of the present invention preferably operates at the frequency range defined between 0.8 MHz˜3.5 MHz. Moreover, a thermometer 40 and a pressure gauge 41 can be provided within the cleaning trough 30 in order to monitor the above operation conditions in the cleaning trough 30. A flow chart 100 for this most preferred embodiment is shown in FIG. 2.

In the supercritical CO₂ cleaning system and method of the present invention, a cleaning device can work in conjunction with co-solvents or surfactants and micro-emulsification technology for objects to be cleaned under different processes in order to achieve the optimum cleaning performance. Because the wafer process or other sophisticated element processes are developed toward the dimension of 65 nm, such that current wet cleaning technologies can not overcome the surface tension under the line width of 65 nm. Further, a lot of super pure water and chemical solvents are needed in the wet cleaning technologies. Accordingly, the supercritical CO₂ cleaning technology is disclosed in the present invention to remove nanopollutants, it can solve convention problems and is a potential ┌Green Cleaning and Producing Technology┐.

Referring to FIG. 5, a diagram for the cleaning principle of a supercritical CO₂ according to the present invention. In this embodiment, the critical temperature of CO₂ is 31.1° C., and the critical pressure thereof is 73 atm. An object to be cleaned can be first put into the closed high-pressure cleaning trough. Liquid CO₂ in the liquid CO₂ tank is then pressurized above the critical pressure by a transmitting pump and heated above the critical temperature by a heater. After entering the supercritical state, CO₂ will enter the cleaning system, and the pollutants can be removed by the properties of low surface tension and high permeability of CO₂. It is noted that the present invention decompresses the supercritical CO₂ containing pollutants through a decompression valve and heavier pollutants will be deposited at the bottom of the trough after the decompression. The pollutants can be collected by an absorbing and filtering apparatus. After a proper treatment, the filtered CO₂ will become a liquid matter by a condenser or after being condensed and enter the CO₂ tank for recycling or being discharged.

It is to be understood that the foregoing general description is exemplary and explanatory only and is not restrictive of the invention as claimed. Various equivalent alterations and modifications can be made without departing from the spirit of the present invention and are within the scope of the following claims.

What is claimed is:

1. A supercritical CO₂ cleaning system, comprising:
a closed high-pressure cleaning trough, which is a funnel-shaped vessel tapered from top to bottom;
a bearer platform, located within said closed high-pressure cleaning trough and rotated with respect to an object to be cleaned and used for bearing said object to be cleaned; and
a movable nozzle set, disposed within said closed high-pressure cleaning trough and above said bearer platform,
wherein said object to be cleaned can be cleaned via said movable nozzle set and impurity pollutants will be easily deposited at the bottom of said closed high-pressure cleaning trough after cleaning.

2. The supercritical CO₂ cleaning system as claimed in claim 1, wherein said bearer platform is titled with respect to the horizontal plane with an angle formed therebetween, during the cleaning, the impurity pollutants can easily and regularly flow away from said object to be cleaned along the angle and reach the bottom of said trough.

3. The supercritical CO₂ cleaning system as claimed in claim 1, wherein said movable nozzle set is the combination of at least one movable nozzle and at least one ultrasonic oscillator having the frequency of 0.8 MHz˜3.5 MHz, said ultrasonic oscillator may form a module together with said movable nozzle, or said ultrasonic oscillator is combined with said bearer platform by mounting it above or beneath said bearer platform.

4. The supercritical CO₂ cleaning system as claimed in claim 3, wherein said ultrasonic oscillator is convergent or non-convergent, the ultrasonic body of said convergent ultrasonic oscillator may form a concave or an additional horn-shaped nozzle is provided in order to achieve the convergence, such that when the supercritical CO₂ flows into said closed high-pressure cleaning trough, it can inject out via said movable nozzle and perform an ultrasonic cleaning.

5. The supercritical CO₂ cleaning system as claimed in claim 3, wherein said ultrasonic oscillator is disposed at a suitable angle with respect said object to be cleaned, such that the impurity pollutants on said object to be cleaned can easily and rapidly leave away.

6. The supercritical CO₂ cleaning system as claimed in claim 3, wherein the operation conditions are as follows: the operation temperature is between 15° C.˜150° C., the operation pressure is between 50˜250 atm, and the operation frequency range of the ultrasonic set is between 0.8 MHz˜3.5 MHz.

7. The supercritical CO₂ cleaning system as claimed in claim 3, wherein within said movable nozzle set, the ultrasonic oscillator pipes, the movable nozzle pipes, and the bearer platform pipes are embedded within a high-pressure tube, such that a second pollution on said object to be cleaned can be avoided.

8. The supercritical CO₂ cleaning system as claimed in claim 3, wherein said object to be cleaned is a wafer, low-k material, or MEMS.

9. A supercritical CO₂ cleaning method comprising:
providing a wafer or an object to be cleaned within a closed high-pressure cleaning trough;
introducing liquid CO₂ into said closed high-pressure cleaning trough;
adding co-solvents and surfactants into said cleaning trough;
activating a movable nozzle set in order to increase the cleaning performance;
rotating said wafer or said object to be cleaned to remove the impurity pollutants; and
lowering the pressure to discharge the CO₂ and the impurity pollutants.

10. The supercritical CO₂ cleaning method as claimed in claim 9, wherein after the CO₂ and the impurity pollutants are discharged, another cleaning can be performed by fresh CO₂, and said wafer or said object to be cleaned can be taken out after this another cleaning.

11. The supercritical CO₂ cleaning method as claimed in claim 10, wherein said wafer or said object to be cleaned is titled with respect to the horizontal plane with an angle formed therebetween, during the cleaning, the impurity pollutants can be easily and regularly discharged.

12. The supercritical CO₂ cleaning method as claimed in claim 10, wherein said movable nozzle set is the combination of at least one movable nozzle and at least one ultrasonic oscillator having the frequency of 0.8 MHz˜3.5 MHz, said ultrasonic oscillator may form a module together with said movable nozzle by mounting it above or additionally underneath said object to be cleaned in order to increase the cleaning performance.

13. The supercritical CO₂ cleaning method as claimed in claim 12, wherein said ultrasonic oscillator of said movable nozzle set is disposed at a suitable angle with respect said object to be cleaned, such that the impurity pollutants on said object to be cleaned can easily and rapidly leave away.

14. The supercritical CO₂ cleaning method as claimed in claim 3, wherein the operation conditions are as follows: the operation temperature is between 15° C.˜150° C., the operation pressure is between 50˜250 atm, and the operation frequency range of the ultrasonic set is between 0.8 MHz˜3.5 MHz.

15. The supercritical CO₂ cleaning method as claimed in claim 12, wherein said object to be cleaned is a wafer, low-k material, or MEMS.

16. The supercritical CO₂ cleaning method as claimed in claim 12, wherein the cleaning can be performed in conjunction with the micro-emulsification technology by adding co-solvents, surfactants and chelating agents in order to increase the cleaning performance.

17. The supercritical CO₂ cleaning method as claimed in claim 12, wherein the work range of said movable nozzle set covers the whole surface of said object to be cleaned, such that said object to be cleaned can be uniformly cleaned.

18. The supercritical CO₂ cleaning method as claimed in claim 12, wherein the respective working ranges of a plurality of ultrasonic waves and a plurality of nozzles in said movable nozzle set overlap with one another, such that any uncleaned areas can be avoided.
